(19) United States
(12) Patent Application Publication
(10) Pub. No.: US 2004/0128297 A1
(43) Pub. Date: Jul. 1, 2004

(54) System for uniform interface with an encapsulated entitlement system

(76) Inventors: Frederick C. Moses, Newton, MA (US); William Campbell, Cambridge, MA (US)

Correspondence Address: Choate, Hall & Stewart, Exchange Place, 53 State Street, Boston, MA, 02109, US

(21) Appl. No.: 10/464,078

(22) Filed: Jun. 17, 2003

Related U.S. Application Data
(63) Continuation of application No. 10/107,570, filed on Mar. 27, 2002, now abandoned.
(60) Provisional application No. 60/279,082, filed on Mar. 27, 2001.

(51) Int. Cl. G06F 7/00

(52) U.S. Cl. 707/100

(57) ABSTRACT

A uniform interface for accessors to an encapsulated entitlement management system, comprising an XML-enabled applications programming interface (API) in communication with one or more accessors and an entitlement management system, wherein the accessors further comprise one or more users or applications desiring access to objects and resources of the entitlement management system, and wherein the API communicates with the accessors over a network.

The present application is a continuation of U.S. patent application Ser. No. 10/107,570, filed Mar. 27, 2002, which claims the benefit of priority to U.S Provisional Application No. 60/279,082 filed Mar. 27, 2001. The contents of both of these related applications are hereby incorporated by reference in their entirety.

### FIELD OF THE INVENTION

The present invention relates generally a uniform interface to an encapsulated entitlement management system. In particular, the system uses an XML-enabled API to access a BMAP server containing entitlement information.

### BACKGROUND OF THE INVENTION

XML (eXtensible Markup Language) is a standard data format for structured document interchange on the Web (W3C Recommendation 6 October 2000, version http://www.w3.org/TR/2000/REC-xml-20001006). Like HTML (hypertext markup language), it is a markup language derived from SGML (standard generalized markup language). However, unlike HTML, which was created to allow cross-platform formatting of information for display, XML is best suited for organizing data. While HTML specifies how a document should be displayed, it does not describe what kind of information the document contains, or how it is organized. XML fills this void and allows document authors to organize information in a standard way. One of XML's primary uses is information exchange between different, and potentially incompatible, systems. Because XML is a text-based, non-binary format and uses syntax rather than binary markers to organize data, it can be used on just about any platform. Although many applications of XML are Internet-related, XML is in no way limited to Internet use. In fact, XML's main strength—organizing information—makes it quite useful for exchanging data between different systems, regardless of whether the Internet is part of the picture.

An application programming interface (API) is a language and message format used by an application program to communicate with an operating system (O/S) or some other system or control program such as a database management system (DBMS) or communications protocol. APIs are implemented by writing function calls in the program, which provide the linkage to the required subroutine for execution. Thus, an API implies that some program module is available in the computer to perform the operation or that it must be linked into the existing program to perform the tasks. Understanding an API is a major part of what a programmer does. Except for writing the business logic that performs the actual data processing, programming consists of writing the code to communicate with the O/S and other software. The APIs for O/Ss can be daunting, especially the calls to display something on screen or to print.

Within any application that requires an authorization procedure, a process of maintaining access control is fast becoming a prerequisite for efficient application management. Connections made to entitlement management systems can often be complicated. What is needed is a way to provide easier connection to an entitlement management system.

Web applications being developed for e-business applications require that entitlement management systems function irrespective of the origin of an accessor's connection attempt. What is needed is a way to provide public remote access to an entitlement management system.

There is a wide array of languages other than Java used in the development of e-business applications. VisualBasic, C++, C, and Smalltalk (just to name a few) must all be considered in developing an API with truly broad utility. What is needed is an API that allows applications written in languages different from Java to access an entitlement management system.

### SUMMARY OF THE INVENTION

It is an object, among others, of the present invention to address the needs described above. To this end, the present invention provides an API that enables easier access, characterized by remote and public connectivity, to an entitlement management system.

It is another object of the present invention to allow applications written in a variety of languages, including but also other than Java, to access an entitlement management system.

By using an API that incorporates XML, the development of a system for access control can be available for all accessors attempting to remotely connect with a server, regardless of the platform being used by the accessor. This will, in effect, provide a system of universal efficiency. With the future of e-business being concurrently developed for a multitude of platforms, such efficiency is necessary requirement.

### BRIEF DESCRIPTION OF THE DRAWING

The invention is described with reference to the several figures of the drawing, in which,

FIG. 1 is a diagram of an entitlement management system using an XML interface according to the invention.

### DETAILED DESCRIPTION OF CERTAIN EMBODIMENTS

Certain embodiments of the invention will now be described with reference to the accompanying drawing.

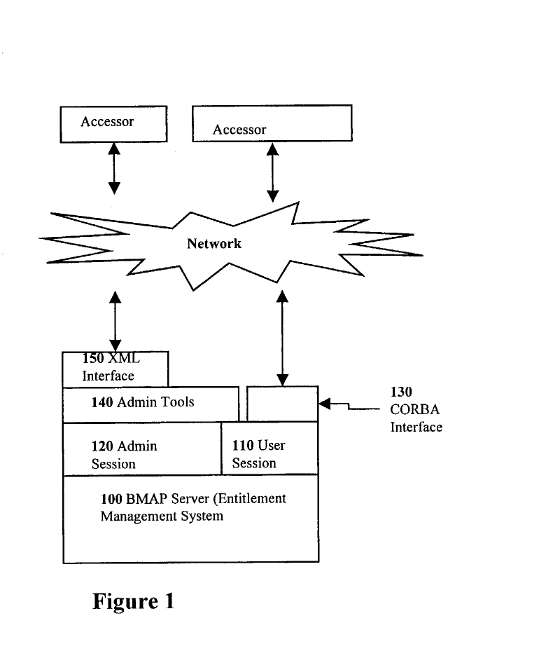

FIG. 1 is a diagram illustrating an XML interface 150 with an entitlement management system. One suitable entitlement management system for use with the invention is the system described in U.S. Pat. No. 6,154,741 to Feldman, entitled “Entitlement Management and Access Control System.” This patent is hereinafter referred to as the “Entitlement Patent” and its teachings are hereby incorporated by reference in their entirety.

FIG. 1 includes BMAP server 100, a user session 110, an admin session 120, a CORBA interface 130, and an XML interface 150.

In operation, all elements in FIG. 1 reside on a host that is connected to the Internet and/or an intranet, from which accessors attempt to connect with the host and gain access to an entitlement management system. The “Entitlement Patent” contains a complete discussion and illustration of the operation of an accessor with an entitlement management system.

FIG. 1 is a diagram illustrating an XML interface 150 with an entitlement management system. One suitable entitlement management system for use with the invention is the system described in U.S. Pat. No. 6,154,741 to Feldman, entitled “Entitlement Management and Access Control System.” This patent is hereinafter referred to as the “Entitlement Patent” and its teachings are hereby incorporated by reference in their entirety. The entitlement management system to which the present invention provides a uniform interface may be implemented using “object-oriented” computer programming techniques. Object-oriented computer programming techniques involve the definition, creation, use and destruction of software entities referred to as “objects.” Each object is an independent software entity comprised of data generally referred to as “attributes” and software routines generally referred to as “member functions” or “methods” or “logic” which manipulate the data.

One characteristic of an object is that only methods of that object can change the data contained in the object. The term “encapsulation” describes the concept of packaging the data and methods together in an object. Objects are thus said to encapsulate or hide the data and methods included as part of the object. Encapsulation protects an object's data from arbitrary and unintended use by other objects and therefore protects an object's data from corruption.

To write an object-oriented computer program, a computer programmer writes computer code that implements a pre-defined model of the system. The object-oriented computer code defines a set of “object classes” or more simply “classes.” Each of these classes serves as a template which defines a data structure for holding the attributes and program instructions which perform the method of an object. Each class also includes a means for instantiating or creating an object from the class template. The means for creating is a method referred to as a “constructor.” Similarly, each class also includes a means for destroying an object once it has been instantiated. The means for destroying is a method referred to as a “destructor.”

When a processor of a computer executes an object-oriented computer program, the processor generates objects from the class information using the constructor methods. During program execution, one object is constructed, which object may then construct other objects which may, in turn, construct other objects. Thus, a collection of objects which are constructed from one or more classes form the executing computer program. Object-oriented computer programming techniques allow computer programs to be constructed of objects that have a specified behavior. Several different objects can be combined in a particular manner to construct a computer program which performs a particular function or provides a particular result. Each of the objects can be built out of other objects that, in turn, can be built out of other objects. This resembles complex machinery being built out of assemblies, subassemblies and so on.

The term “client object,” or more simply “client,” refers to any object that uses the resources of another object which is typically referred to as the “server object” or “server.” The entitlement management system may be implemented as one or more server objects which can be accessed by client objects seeking entitlement information by the invocation of one or more entitlement manager methods. In addition, objects and some other software applications can communicate using a “publish/subscribe” protocol where an object publishes information, sometimes called an “event,” that is received by all other objects that subscribe to that event. The entitlement management system can control the broadcast of events by determining which users should receive the “event” publication.

The term “framework” can refer to a collection of inter-related classes that can provide a set of services (e.g., services for network communication) for a particular type of application program. Alternatively, a framework can refer to a set of interrelated classes that provide a set of services for a wide variety of application programs (e.g., foundation class libraries for providing a graphical user interface for a Windows system). A framework thus provides a plurality of individual classes and mechanisms which clients can use or adapt.

An application framework refers to a set of classes which are typically compiled, linked and loaded with one particular application program and which are used by the particular application program to implement certain functions in the particular application program. A system framework, on the other hand, is provided as part of a computer operating system program. Thus, a system framework is not compiled, linked and loaded with one particular application program. Rather, a system framework provides a set of classes which are available to every application program being executed by the computer system which interacts with the computer operating system.

FIG. 1 illustrates a distributed software environment 10 for establishing a session with an entitlement management system, which in the present invention is BMAP server 100 (refer to “Entitlement Patent” for complete description of the operation of BMAP server 100). Commonly used in the art, CORBA (Common Object Request Broker Árchitecture) interface 130 allows accessors using all programming languages that enable COM (Component Object Model; objects that can be run remotely over the network in a distributed objects environment) to establish a session with BMAP server 100. The services provided by middleware such as CORBA interface 130 include sets of distributed software that exist between application and the operating system and network services on a system node in a network. Middleware services provide a more functional set of Application Programming Interfaces (APIs) than most operating systems or network services and allow an application to locate transparently across a network, providing interaction with another application or service, be independent from network services, be reliable and available, and scale up in capacity without losing function. It is often desirable to provide applications for use on the Internet based on middleware to provide those applications with the availability and scalability that middleware allows. The entitlement management system may be provided as a portion of, or a plug-in to, middleware software for the purpose of providing entitlement management functionality to an accessor or client processes through one or more APIs.

User session 110 (also referred to as a plain session) and admin session 120 may use CORBA interface 130 to communicate with applications and systems operating in various languages that are COM-enabled. The difference between the sessions is that admin session 120 allows for updating of information in BMAP server 100 (encompassing accessors, group lists, and object registries—the extent of which is covered more fully in the “Entitlement Patent”), while user session 110 constitutes a read-only communication with BMAP server 100.

Specific to the purposes of this application, XML interface 150 serves as a uniform interface with BMAP server 100 by enabling connectivity for both user session 110 and admin session 120. Administrative tools 140 represent an optional bundle of programmatic administrative mechanisms stored on the host server that may be provided in order to allow XML interface 150 to communicate with the sessions. Similar to CORBA interface 130, XML interface 150 can interface with all COM-enabled languages. A key difference, however, is that XML interface 150 allows for bulk loading and exporting of information from BMAP server 100, thus greatly improving the scalability of an entitlement management system. Additionally, XML's projected adoption as a cross-platform standard for networked applications provides a way for BMAP server 100 to be accessed and bulk updated regardless of the legacy code or current language used in the programming and maintenance of the accessor's native application. Such uniform interface capabilities (whether via CORBA interface 130 or using the XML interface 150) provide a way for all devices to speak to BMAP server 100 regardless of the accessor's platform orientation.

In certain embodiments of the invention, there are both pure Java and CORBA interfaces to the admin session 120 and user session 110. These provide access to the basic functionality of BMAP server 100. The XML interface 150 is implemented above the admin session 120 and use session 110 and may provide access to all the basic BMAP functions of those sessions expressed as XML.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A uniform interface for accessors to an encapsulated entitlement management system, comprising:
an XML-enabled applications programming interface (API) in communication with one or more accessors and an entitlement management system, wherein the accessors further comprise one or more users or applications desiring access to objects and resources of the entitlement management system, and wherein the API communicates with the accessors over a network.

2. The uniform interface of claim 1, wherein the API facilitates connectivity with applications written in languages that support Component Object Models.

3. The uniform interface of claim 1, wherein the API facilitates the importation of legacy data into the entitlement management system.

4. The uniform interface of claim 1, wherein the API enables bulk loading and unloading of data to and from the entitlement management system.

5. The uniform interface of claim 1, wherein the accessors and entitlement management system are remote from each other in the network.

6. The uniform interface of claim 1, wherein the API provides accessors with access to entitlement management system functions.

7. The uniform interface of claim 6, wherein the entitlement management system functions comprise adding, removing, updating and assigning identification numbers to accessors information stored in the entitlement management system.

8. The uniform interface of claim 6, wherein the entitlement management system functions comprise adding, removing, updating and assigning identification numbers to object information stored in the entitlement management system.

9. The uniform interface of claim 6, wherein the entitlement management system functions comprise adding, removing, updating and assigning identification numbers to user preference information stored in the entitlement management system.
